(19) United States
(12) Patent Application Publication
(10) Pub. No.: US 2002/0191551 A1
(43) Pub. Date: Dec. 19, 2002

(54) Method and system for redefinition of an interface

(76) Inventors: Vesa Heikkila, Oulu (FI); Tom Vernoou, Singapore (SG)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/133,589

(22) Filed: Apr. 29, 2002

Related U.S. Application Data
(63) Continuation of application No. PCT/FI00/00807, filed on Sep. 21, 2000.

(30) Foreign Application Priority Data
Oct. 29, 1999 (FI) 19992342

(51) Int. Cl. H04L 12/16; H04J 7/00; H04M 1/00

(52) U.S. Cl. 370/271; 370/212; 379/339

(57) ABSTRACT

The invention concerns a method and a system for ensuring successful setup of calls in a telephone exchange system comprising a local exchange (LE), an access node (AN) and a concentrating V5 interface (V5) connecting the access node (AN) to the local exchange (LE). In the method, the concentrating interface (V5) is divided into two or more parts.

### FIELD OF THE INVENTION

The present invention relates to telecommunication systems. In particular, the invention concerns a new type of method and system for ensuring successful call setup and giving an announcement to the subscriber.

### BACKGROUND OF THE INVENTION

Open interfaces (V5.1 and V5.2) between an access network and a local exchange are defined in the ETSI (European Telecommunications and Standards Institute) standards of the ETS 300 324 and ETS 300 347 series. V5 interfaces enable subscribers belonging to a physically separate access network to be connected to a telephone exchange using a standard interface. A dynamic concentrator interface V5.2 consistent with the ETS 300 347-1 and 347-2 standards consists of one or more (1-16) PCM (Pulse Code Modulation) lines. One PCM line comprises a total of 32 channels or time slots, each having a transfer rate of 64 kbit/s, the total capacity of the PCM line being thus 2048 kbit/s. The V5.2 interface supports analogue telephones as used in the public telephone network, digital, such as ISDN (Integrated Services Digital Network) basic rate and primary rate interfaces as well as other analogue or digital terminal equipment based on semipermanent connections.

The maximum capacity of a single V5.2 interface is about 500 B-channels. This means that there may be about 500 calls going on simultaneously. However, as the V5.2 interface is of a concentrating type, this number of B-channels is sufficient to serve about 5000 subscribers. The subscribers may be connected to the local exchange e.g. via a special access node. The access node communicates with the local exchange e.g. via a V5 interface. An example of this type of access nodes is the DAXnode 5000 manufactured by the applicant.

The access node may comprise resources that are scanned and dynamically allocated. Subscribers can be connected to the access node via a remote subscriber stage (RSS) , in which case the module line between the remote subscriber stage and the access node is used to concentrate subscribers to be connected to the access node. Moreover, subscribers can be connected to the access node via a wireless local loop system (WLL, Wireless Local Loop), allowing subscribers to be concentrated in the interface between the access node and the radio network. In this context, ‘concentrating’ means in practice that not all subscribers can communicate with the access node at the same time, the capacity being only sufficient for a part of the total number of subscribers.

Besides the actual signalling traffic, the V5 interface specifications comprise separate O&M interfaces (O&M, Operation and Maintenance) for the local exchange and the access network. A local exchange management interface Q3 is defined in ETSI standards ETS 300 379-1 and ETS 300 377-1. Management interface means an interface between a local exchange and a management network (TMN, Telecommunications Management Network).

The V5 interface comprises two time slot types: time slots reserved for speech, i.e. B-channels, and time slots reserved for signalling data, i.e. C-channels. In the V5.2 interface, backup channels are additionally used as backup for the signalling channels. If a single 2 Mbit/s transmission link is used, the system automatically reserves time slot 16 for the control protocol. Time slots 16, 15 and 31 may be reserved both for the public telephone network and for ISDN channels. If more than one transmission links are used, then the system automatically reserves time slot 16 of the primary transmission link for the control, transmission link control, BCC (Bearer Channel Connection) and backup protocols. In the secondary transmission link, time slot 16 is also reserved as backup channel. The V5 interface backup mechanism ensures that a V5.2 interface comprising many transmission links will function even after a failure of an individual PCM transmission link. The backup mechanism is used to back up all active C-channels. The backup protocol does not cover the speech channels. Time slots 1-31 can be reserved for the following purposes:

ISDN and PSTN (PSTN, Public Switched Telephone Network) B-channel,

liaison channel carrying ISDN D-channel information, PSTN-signalling or control data, or

liaison channel carrying information pertaining to the Control protocol, Link control protocol, Protection protocol or BCC protocol of the V5 interface.

The protocols covered by the V5.2 interface specification include the Control and PSTN protocols. The function of the Control protocol is e.g. to create signalling channels during the call setup procedure, to control the states of access ports and to cooperate with the Protection protocol in a situation where the signalling channel link is broken off. The Protection protocol protects the signalling channels e.g. in the case of a malfunction in the PCM line. The function of the PSTN protocol is e.g. to transmit access line status data to the access node in the case of an analog subscriber. In addition, the PSTN protocol functions as a means of communication with national PSTN specifications. The BCC protocol takes care of allocation and release of time slots in a concentrating interface. The protocols associated with the V5 interface are described in greater detail in the ETSI standard series ETS 300 324 and ETS 300 347.

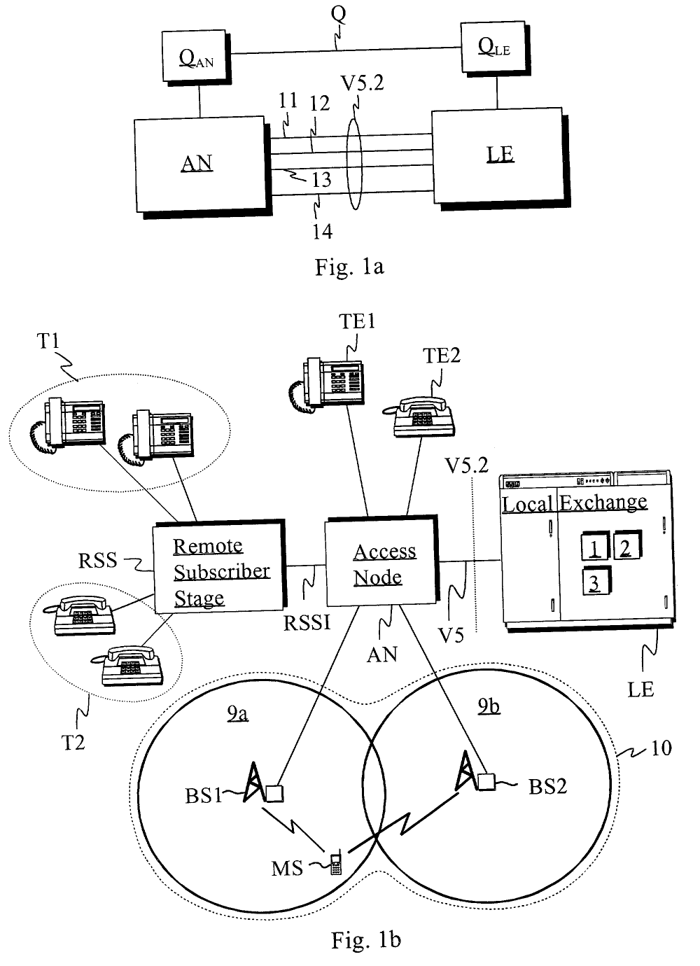

FIG. 1a presents a system comprising a V5.2 interface as defined in the ETS 300 347 standard series. The system illustrated in FIG. 1a comprises an access node AN and a local exchange LE. In this example, the access node is connected to the local exchange via a V5.2 interface comprising links 11-14.

Provided in the access node AN is management interface Q_{AN} and in the local exchange LE management interface Q_{LE}, allowing the local exchange and access node to be controlled via the management interfaces Q_{LE} and Q_{AN}. The boundaries between and structures of the management interfaces are defined in the standards. The local exchange and the access node communicate with the Q-interface via the management interfaces Q_{LE} and Q_{AN}. According to the above-mentioned standard, the operator can also define in the interface fixed or semipermanent time slot connections for certain subscribers.

If all resources are occupied, then a problem is encountered in the task of ensuring successful setup of particularly important calls, e.g. emergency calls. ‘Resources’ means e.g. the time slots reserved for subscribers in a concentrating interface. When a call is being set up from the local exchange to the access node or vice versa, the local exchange selects the V5.2 interface link to be used and a suitable time slot in that link. The BCC protocol, as defined in the V5 standard, informs the access node about the link and time slot to allow the call to be set up. In the case of an outgoing call, i.e. when a call is set up from the access node to the local exchange, it is possible that there is no resource available for the call in the interface between the access node and the local exchange due to an overload situation in the interface, which means that the call fails. In practice, the A-party does not get a dialling tone because no voice time slot can be allocated for the call in the concentrating interface. A corresponding problem appears in the case of a call terminating at the access node.

### OBJECT OF THE INVENTION

The object of the present invention is to eliminate the problems described above. A specific object of the invention is to disclose a new property for the V5.2 interface that will make it possible for a subscriber to make e.g. emergency calls even if all time slots reserved for normal calls should be occupied. Further, in the solution of the invention, the subscriber's terminal equipment will always get some kind of response to a call setup attempt. The response is preferably a response produced by a tone generator in the local exchange, or it may be an appropriate announcement.

As for the features characteristic of the invention, reference is made to the claims.

### SUBJECT OF THE INVENTION

The invention concerns a method that will ensure that, when a subscriber is trying to set up a call, the call can be connected if it is really necessary. Further, according to the method of the invention, the subscriber's telecommunication terminal will always get some kind of response from the local exchange, even if the voice time slots reserved for calls should be occupied. The telephone exchange system of the invention preferably comprises a local exchange, an access node and a concentrating interface connecting the access node to the local exchange. The concentrating interface is preferably a V5.2 interface. The local exchange is preferably a DX 200 manufactured by the applicant.

According to the invention, the concentrating interface is divided into two or more parts.

In a preferred embodiment of the invention, the concentrating interface is divided into two parts. Time slots in the second part are only allocated in an overflow situation where all the time slots reserved for use in the first part have been allocated. In addition, the subscriber may be given in the above-mentioned time slot an announcement about a congestion situation. Further, the subscriber is only allowed to dial certain numbers, e.g. emergency numbers. There is a limited number of time slots reserved for overflow situations, so that only extremely important calls can be set up. This limitation ensures that ordinary calls will not occupy time slots in the second part. Moreover, it is possible to make modifications in the local exchange that will only allow calls to emergency numbers.

The first and second parts can be implemented e.g. so that they constitute two separate circuit groups comprising different numbers of B-channels. Most of the channels belong to the first part and the rest to the second part. Alternatively, the implementation may be such that the local exchange manages the B-channels of the concentrating interface in accordance with a given relationship. For instance, 95% of the time slots can be defined as belonging to the first part while the remaining 5% belong to the second part, the overflow circuit group. The solutions described above do not require any changes to be made in the operation of the access node. It only connects those B-channels that the local exchange assigns.

In a preferred embodiment of the invention, in the concentrating interface a part is defined which comprises one or more time slots for connecting a tone generator to the access node via a semipermanent connection. In these time slots, e.g. various announcements or other signals produced by a tone generator can be transmitted. The access node connects the subscriber to the semipermanently connected time slot, which carries a tone from the local exchange. The time slot used by the tone generator cannot be connected as a normal voice time slot for a subscriber, whereas the same announcement time slot associated with the tone generator can be connected for several subscribers.

In a preferred embodiment of the invention, a time slot defined for a tone generator with a semipermanent connection is connected for a subscriber if one or more parts defined in the concentrating interface run out of time slots available to it. The access node connects the subscriber to the semipermanently connected time slot, which carries a tone from the local exchange. The concentrating interface may additionally comprise e.g. two other parts defined in it: a part reserved for normal calls and an overflow part reserved for very important calls. When a subscriber wants to set up a call, a time slot in the part reserved for normal calls is primarily allocated to him. If all the time slots are busy, then a time slot in the overflow part can be allocated if necessary. Sometimes even all the time slots in the overflow part may be occupied. In such a situation, a time slot defined for the tone generator via a semipermanent connection is connected for the subscriber. The access node connects the subscriber to the semipermanently connected time slot, which carries a tone from the local exchange. Thus, the subscriber will always get some kind of response, regardless of an overload situation in the part reserved for normal calls and in the overflow part.

In a preferred embodiment of the invention, the concentrating interface is divided into two parts. The first part is reserved for normal calls. The second part comprises one or more time slots which are used to connect a tone generator via a semipermanent connection to the access node. If the first part runs out of time slots, then a time slot associated with the tone generator is connected for the subscriber and, using this time slot, the subscriber is given an announcement about a congestion situation. ‘Announcement’ may also mean some other response produced by the tone generator. Thus, if the first part has run out of time slots because of congestion, the subscriber can not set up a call at all. He is only presented an announcement using a time slot associated with the tone generator. This ensures that, when the first part runs out of time slots, the subscriber's call attempt will not be rejected without any response at all.

In the system of the present invention, a concentrating interface is divided into two or more parts.

In a preferred embodiment of the invention, the concentrating interface is divided into two parts. Moreover, the system comprises an allocator by means of which time slots of the second part are only allocated in an overflow situation where the first part runs out of time slots.

In a preferred embodiment of the invention, the concentrating interface is divided into two parts. The system comprises an allocator by means of which time slots of the second part are allocated in an overflow situation where the first part runs out of time slots. Moreover, the system comprises a tone generator by means of which the subscriber is informed about a congestion situation and given a dial tone. Furthermore, the system comprises a selector which only allows the subscriber to dial certain numbers, e.g. emergency numbers.

In a preferred embodiment of the invention, the concentrating interface contains a part so defined that it comprises one or more time slots used to connect a tone generator via a semipermanent connection to the access node.

In a preferred embodiment of the invention, the system comprises an allocator, which is used to connect for the subscriber a time slot defined for a tone generator with a semipermanent connection, and a tone generator, which is used to give the subscriber in the said time slot an announcement about a congestion situation or some other response produced.

In a preferred embodiment of the invention, the concentrating interface is a V5.2 interface.

As compared with prior art, the present invention has the advantage that the subscriber is never left without a response in conjunction with a call setup attempt. Thus, the subscriber will not be left in an uncertainty as to whether a call can be set up or not. The subscriber receives via his telecommunication terminal an announcement about the congestion situation and/or a dial tone for emergency calls. Moreover, the implementation of the invention does not require any special functionality in the access node.

The invention makes it possible to ensure the accessibility of important numbers in situations of crisis, congestion and the like where it is absolutely necessary to be able to set up a call.

### LIST OF ILLUSTRATIONS

In the following, the invention will be described in detail by the aid of some of its embodiments, wherein

FIG. 1a presents a system comprising a V5.2 interface consistent with the ETS 300 347 standard series,

FIG. 1b presents a preferred system according to the invention,

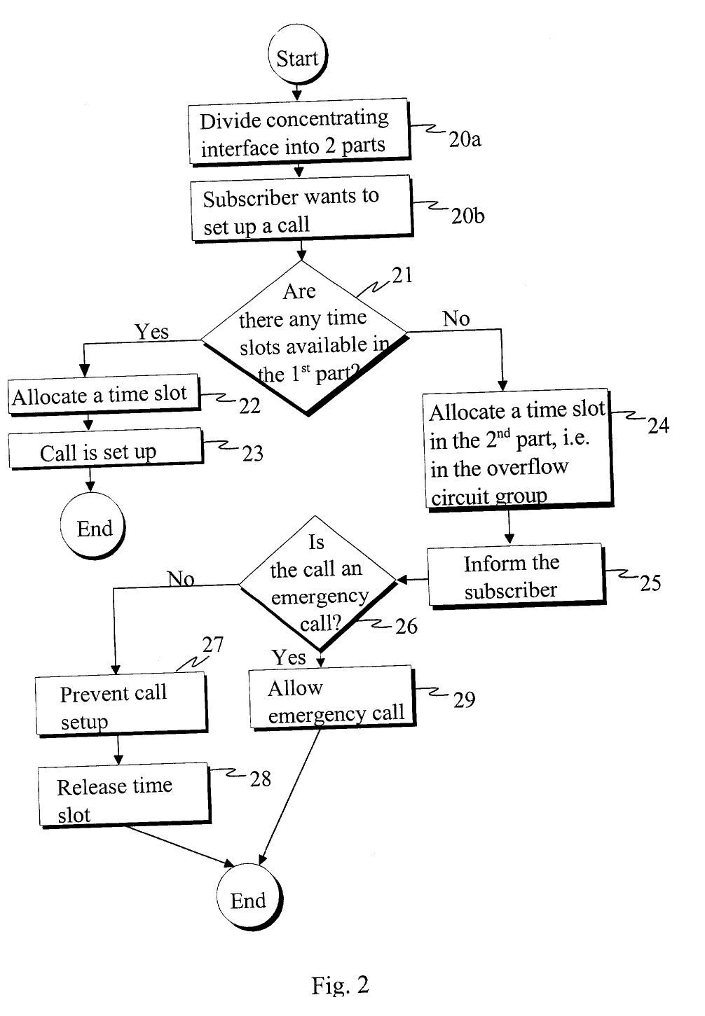

FIG. 2 presents a flow diagram representing a preferred example of the operation of the present invention,

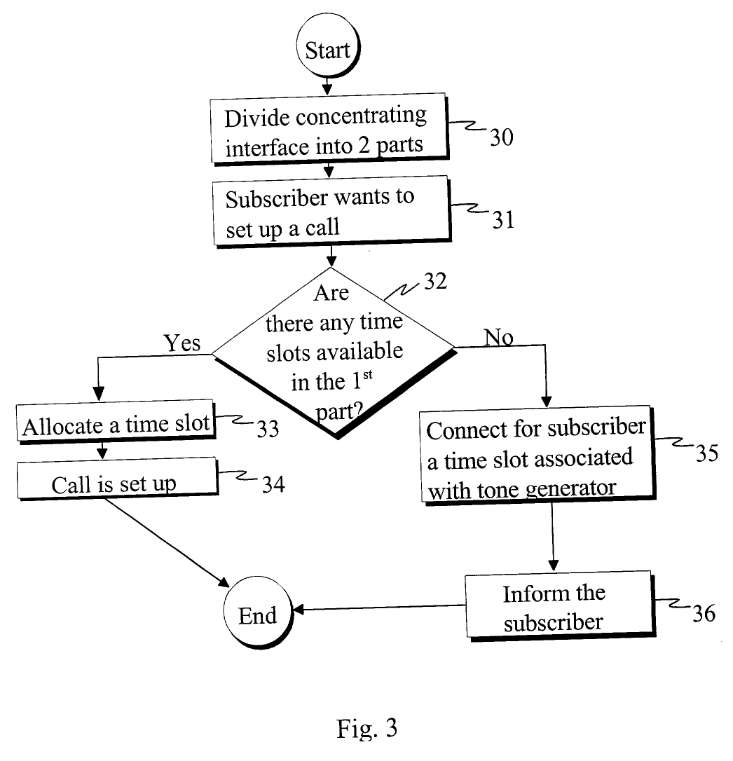

FIG. 3 presents a flow diagram representing a preferred example of the operation of the present invention, and

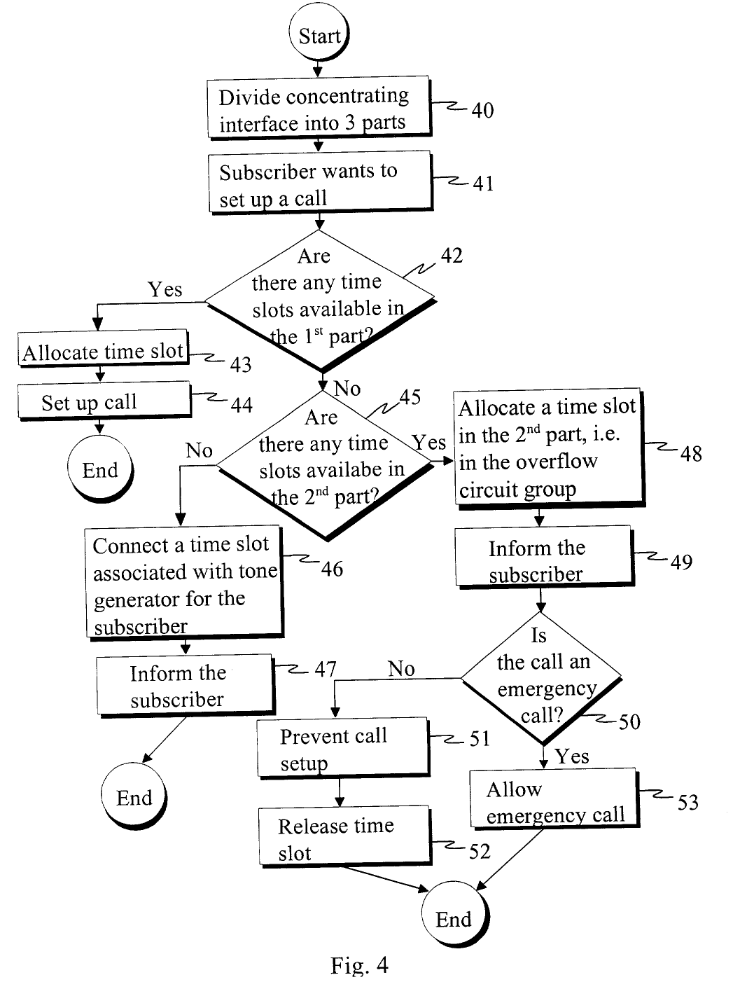

FIG. 4 presents a flow diagram representing a preferred example of the operation of the present invention.

### DETAILED DESCRIPTION OF THE INVENTION

FIG. 1b presents an example of a system in which the invention can be implemented. The system comprises a local exchange LE and an access node AN connected to the local exchange via a V5 interface. The interface between the local exchange LE and the access node AN is called V5.2 interface. The functionality of the V5 interface and the V5.2 interface are described in greater detail in the above-mentioned standard series ETS 300 347.

Subscribers can be connected to the local exchange LE and access node AN in many different ways. FIG. 1b presents a few examples of different connections. Connected directly to the access node AN are two pieces of terminal equipment. In this example, terminal equipment TE1 is a digital ISDN telephone and terminal equipment TE2 is an analog telephone. Connected to the access node is also a wireless local loop (WLL), in which a telecommunication terminal MS is connected to the access node via the WLL system. The WLL system comprises at least one base station BS, which is connected to the access node via an Abis interface. This example comprises two base stations BS1 and BS2, forming cell areas 9a and 9b. The access node AN controls the operation of the base stations. Together, the cell areas constitute a mobility area 10, which in this example is the working range defined for the mobile station MS. The access node AN is connected via a V5 interface to the local exchange LE, so that, as seen by the local exchange LE, the WLL system terminal MS is a normal wired-network subscriber.

The system presented in FIG. 1b additionally comprises a remote subscriber stage RSS connected via a concentrating interface RSSI to the access node. The concentrating interface is e.g. a PCM line. As shown in FIG. 1b, there are two subscriber groups T1 and T2 connected to the remote subscriber stage. Subscriber group T1 consists of ISDN subscribers and subscriber group T2 consists of PSTN subscribers (PSTN, Public Switched Telephone Network).

Although not illustrated here, it is obvious that the telephone network may be a considerably larger entity than the system presented in FIG. 1b. The telephone network may comprise several telephone exchanges, access nodes and other network components.

In a system as illustrated in FIG. 1b, both the local exchange LE and the access node AN implement functions consistent with the BCC protocol. The BCC protocol at the local exchange allocates the resources to be used in a call, such as time slots, and releases the allocations in the V5.2 interface. In practice, the BCC protocol thus manages the use of resources in the concentrating V5 interface.

The concentrating interface V5 is divided into two or more parts. The division is managed e.g. using a special counter which keeps a record of the use of time slots. The counters are placed e.g. in circuit group files. If the concentrating interface has been divided into two parts, the division can be defined e.g. so that the first part comprises 95% of the time slots in the interface while the remaining 5% belong to the second part, the overflow circuit group.

The time slots in a given part of the interface are allocated by means of an allocator 1. For instance, when the interface has been divided into two parts, the allocator 1 will only allocate time slots of the second part in a situation where all the time slots reserved for use in the first part are busy. The allocator 1 is e.g. a resource manager or a BCC protocol object. The function of the resource manager is to maintain information regarding the total number of voice time slots in the concentrating interface and the number of time slots needed by different subscriber groups. Another function of the resource manager is to update the time slot counters in accordance with the scanning requests, so it will be immediately informed about possible congestion of resources. Based on a request received in a scanning file, the resource manager also decides whether a free time slot can be found for a call.

The local exchange LE also comprises a tone generator 2, which is used to inform the subscriber about a congestion situation and to give the subscriber a dial tone. In the V5.2 interface, one or more time slots can be reserved for the purpose of connecting the tone generator 2 via a semipermanent connection to the access node AN. The access node connects the subscriber to the semipermanently connected time slot, which carries a tone from the local exchange LE. A time slot associated with the tone generator 2 can be connected to several subscribers at the same time if necessary. Using a selector 3, the subscriber is only allowed to dial certain numbers. Such numbers include e.g. emergency numbers. The arrangement for allowing only certain numbers is implemented e.g. by modifying the dialling analysis parameters so that the local exchange LE will only accept diallings consisting of certain predetermined numbers.

The allocator 1 and the selector 3 are preferably implemented as program blocks using a computer.

FIG. 2 presents a preferred example of the operation of the present invention in the form of a flow diagram. As indicated in block 20a, the concentrating interface in this example is divided into two parts. The time slots in the first part can be allocated for normal calls. The time slots in the second part constitute a so-called overflow circuit group, and these can only be used for very important calls, e.g. emergency calls. In block 20b, a subscriber wants to set up a call. The local exchange receives the request and checks whether there are any free time slots left in the first part, block 21. If time slots are available in the first part, then a time slot is allocated, block 22. The call can thus be set up, block 23.

If no free time slots are found in the first part, then the procedure goes on to block 24, where a time slot in the second part is allocated. In this example, the second part is called an overflow circuit group. Thus, the overflow circuit group is only used in situations where the first part has run out of free time slots.

As indicated in block 25, before connecting the dial tone, the local exchange gives the subscriber an announcement or a response produced by the tone generator. The announcement may say e.g.: “Because of temporary congestion, only emergency calls are allowed”. After the announcement, the subscriber is given a dial tone and allowed to dial certain numbers, e.g. emergency numbers. If the subscriber is not calling an emergency number, then the procedure goes on via block 26 to block 27. In block 27, call setup is stopped. After this, the time slot reserved in the overflow circuit group is released, block 28. In the local exchange, it is possible to make definitions that only allow calls to be connected to certain numbers, e.g. emergency numbers. This prevents the use of the overflow circuit group for normal calls.

If the number dialled by the subscriber is an emergency number or other allowed number, then the dialling is accepted and the call is connected, block 29.

In view of actual congestion situations, it is important to design the overflow circuit group correctly. If the overflow circuit group has been incorrectly designed (the number of time slots reserved for use is too small), then this may result in congestion in situations where successful call setup would be of utter importance.

FIG. 3 presents a preferred example of the operation of the invention in the form of a flow diagram. As indicated in block 30, in this example a concentrating interface is divided into two parts. The time slots in the first part can be allocated for normal calls. The second part consists of one or more time slots used to connected a tone generator to the access node via a semipermanent connection. Using the time slots in the second part, the subscriber can be given different announcements or other responses produced by the tone generator. Therefore, the time slots in the second part cannot be used for actual calls by subscribers.

As indicated in block 31, a subscriber wants to set up a call. The local exchange receives the request and checks whether there are any free time slots left in the first part, block 32. If free time slots are found, then a time slot is allocated, block 33. The call can thus be set up, block 34.

If no free time slots are found in the first part, then the procedure goes on to block 35, where a time slot associated with the tone generator is connected for the subscriber. Using this time slot, the subscriber is informed about a congestion situation where all time slots in the first part are already occupied, block 36.

In the example presented in FIG. 3, a free voice time slot available to the subscriber for an actual call is not necessarily found. However, the subscriber can be informed about the situation by using the time slots associated with the tone generator in the second part. Although no actual call can be set up, the subscriber is still not left completely without a response.

FIG. 4 presents an example of the operation of the present invention in the form of a flow diagram. As indicated in block 40, in this example a concentrating interface is divided into three parts. The time slots in the first part can be allocated for normal calls. The time slots in the second part form a so-called overflow circuit group, and these can only be used for important calls, e.g. emergency calls. Thus, the time slots in the second part can only be used in a situation where all the time slots in the first part are already occupied. The third part consists of one or more time slots, which are used to connect a tone generator to the access node via a semipermanent connection. The access node connects the subscriber to the semipermanently connected time slot, which carries a tone from the local exchange. Using the time slots in the third part, the subscriber can be given various announcements or other responses produced by the tone generator. Thus, the time slots in the third part cannot be used for actual calls by the subscriber.

As indicated in block 41, a subscriber wants to set up a call. The local exchange receives the request and checks whether there are any free time slots left in the first part, block 42. If free time slots are found, then a time slot is allocated, block 43. The call can thus be set up, block 44.

If no free time slots are found in the first part, then the procedure goes on to block 45, where an attempt is made to allocate a time slot in the second part. In this example, the second part is called an overflow circuit group. Thus, the overflow circuit group is only used in situations where the first part has run out of free time slots. If all the time slots in the second part, too, are already occupied, then a time slot associated with the tone generator is connected for the subscriber, block 46. The tone generator transmits an announcement or other response about the prevailing congestion situation to the subscriber, block 47. Thus, the subscriber receives a response to his call attempt despite the fact that no actual call can be set up.

If there are any time slots available for use in the second part, then a time slot is allocated to the subscriber, block 48. As indicated in block 49, the local exchange sends an announcement to the subscriber before giving a dial tone. The announcement comes from a tone generator. The announcement says e.g.: “Due to temporary congestion, only emergency calls are allowed.” After the announcement, the subscriber is given a dial tone. If the subscriber is not calling an emergency number, then the procedure goes on via block 50 to block 51. In block 51, call setup is stopped. After this, the time slot reserved in the overflow circuit group is released, block 52. In the local exchange, definitions can be made that allow a call to be only connected to certain numbers, e.g. emergency numbers. This prevents the use of the overflow circuit group time slots for normal calls.

If the number dialled by the subscriber is an emergency number or other allowed number, then the dialling is accepted and the call is connected, block 53.

In view of actual congestion situations, it is important to design the overflow circuit group correctly. If the overflow circuit group has been incorrectly designed (the number of time slots reserved for use is too small), then this may result in congestion in situations where successful call setup would be of utter importance. In the example presented in FIG. 4, a free voice time slot available to the subscriber for an actual call is not necessarily found. However, the subscriber can be informed about the situation by using the time slots associated with the tone generator in the third part. Although no actual call can be set up, the subscriber is still not left completely without a response.

The invention is not restricted to the examples of its embodiments described above, but many variations are possible within the scope of the inventive idea defined in the claims.

1. Method for ensuring successful setup of calls and giving an announcement to the subscriber in a telephone exchange system comprising:
a local exchange (LE),
an access node (AN),
a concentrating interface (V5 ) connecting the access node (AN) to the local exchange (LE),
characterized in that the method comprises the steps of:
dividing the concentrating interface (V5 ) into two or more parts; and
giving the subscriber an announcement if the first part is congested.

2. Method as defined in claim 1, characterized in that
the concentrating interface (V5 ) is divided into two parts; and
time slots in the second part are only allocated in an overflow situation where all the time slots reserved for use in the first part are occupied.

3. Method as defined in claim 1, characterized in that
the concentrating interface (V5 ) is divided into two parts; and if the first part runs out of free time slots, then
a time slot in the second part is allocated to the subscriber;
the subscriber is given an announcement regarding the congestion situation using the said time slot; and
the subscriber is only allowed to dial certain numbers.

4. Method as defined in claim 1, characterized in that, in the concentrating interface (V5 ), a part is defined that comprises one or more time slots used to connect a tone generator to the access node (AN) via a semipermanent connection.

5. Method as defined in any one of the preceding claims 1-4, characterized in that, if one or more parts defined in the concentrating interface (V5 ) runs out of available time slots, then
a time slot defined for the tone generator with a semipermanent connection is connected for the subscriber; and
the subscriber is given an announcement about the congestion situation using the said time slot.

6. Method as defined in any one of the preceding claims 1-5, characterized in that the interface is divided into two parts in a predetermined proportion.

7. Method as defined in any one of the preceding claims 1-6, characterized in that the concentrating interface (V5 ) is a V5.2 interface.

8. System for ensuring successful setup of calls and giving an announcement to the subscriber in a telephone exchange system comprising:
a local exchange (LE),
an access node (AN),
a concentrating interface (V5 ) connecting the access node (AN) to the local exchange (LE),
characterized in that, in the system:
the concentrating interface (V5 ) is divided into two or more parts; and that
the system further comprises a tone generator (2) by means of which the subscriber is informed about a congestion situation and given a dial tone.

9. System as defined in claim 8, characterized in that in the system:
the concentrating interface (V5 ) is divided into two parts; and that the system comprises:
an allocator (1), by means of which time slots in the second part are only allocated in an overflow situation where the time slots received for use in the first part are all occupied.

10. System as defined in claim 8, characterized in that, in the system:
the concentrating interface (V5 ) is divided into two parts; and that the system comprises:
an allocator (1), by means of which time slots in the second part are only allocated in an overflow situation where the time slots reserved for use in the first part are all occupied; and
a selector (3), which is used in a congestion situation to allow the subscriber to dial only certain numbers.

11. System as defined in claim 8, characterized in that, in the system:
a part has been defined in the concentrating interface (V5 ) which comprises one or more time slots for connecting the tone generator (2) via a semipermanent connection to the access node (AN).

12. System as defined in any one of the preceding claims 8-11, characterized in that the system comprises:
an allocator (1), by means of which a time slot defined for a tone generator (2) with a semipermanent connection is connected for the subscriber; and
a tone generator (2), by means of which the subscriber is given in the said time slot an announcement concerning a congestion situation or some other response produced.

13. System as defined in any one of the preceding claims 8-12, characterized in that the concentrating interface (V5 ) is a V5.2 interface.
